(19) United States
(12) Patent Application Publication
(10) Pub. No.: US 2012/0267573 A1
(43) Pub. Date: Oct. 25, 2012

(54) METHOD FOR MAKING FLUORESCENT GOLD NANO-MATERIAL

(76) Inventors: Jau-Yann WU, Kaohsiung City (TW); Ting-Fan Chou, Kaohsiung City (TW); Huy-Zu Cheng, Kaohsiung City (TW); Shih-Han Wang, Kaohsiung City (TW); Li-Feng Liu, Kaohsiung City (TW); Chih-Yu Wang, Kaohsiung City (TW); Jia-Jung Wang, Kaohsiung City (TW); Wan-Nan U Chen, Kaohsiung City (TW); Chien-Fu Huang, Kaohsiung City (TW); Shen-Li Fu, Kaohsiung City (TW); Ta-Nung Hsieh, Kaohsiung City (TW)

(21) Appl. No.: 13/293,211

(22) Filed: Nov. 10, 2011

(30) Foreign Application Priority Data
Apr. 20, 2011 (TW) 100113689

(51) Int. Cl. C09K 11/06; B82B 3/00

(52) U.S. Cl. 252/301.16; 977/896

(57) ABSTRACT

A method for making a fluorescent gold nano-material having a gold nanocluster and thiol ligands on a surface of the gold nanocluster includes reacting a mixture of a gold-containing compound, an alkyl alcohol, and a thiol compound.

### CROSS-REFERENCE TO RELATED APPLICATION

This application claims priority of Taiwanese application No. 100113689, filed on Apr. 20, 2011.

### BACKGROUND OF THE INVENTION

1. Field of the Invention

This invention relates to a method for making a fluorescent gold nano-material, more particularly to a method for making a fluorescent gold nano-material that emits red fluorescence.

2. Description of the Related Art

Because gold nanoparticles and gold nanoclusters have specific optical properties, electrochemical properties, surface functional properties etc., they are widely used in the fields of nanoelectronics, biomedical science, and catalysis. The gold nanoclusters are extremely small, each of which usually consists of about several to several tens of atoms. Thus, the gold nanoclusters have poor stability and dispersity, and are likely to aggregate.

In order to overcome the aforesaid drawbacks, organic ligands (for example, thiol ligands from a thiol compound) are used to modify a surface of the gold nanoparticle or the gold nanocluster.

In J. AM. CHEM. SOC. 2008, 130, 1138-1139, Mr. Zhu et al disclose alkylthiol or arylthiol modified gold nanoclusters. The procedure for forming the modified gold nanoclusters involves two steps: (i) reduction of Au(III) (e.g., HAuCl₄) to Au(I) using thiols so as to form an intermediate of Au(I):SR complexes, where R can be alkyl- or aryl, and (ii) further reduction of Au(I) to Au(0) using a strong reducing agent (e.g., NaBH₄). In this procedure, although the modified gold nanoclusters thus prepared have enhanced fluorescence intensity and light stability, the strong reducing agent is required. Moreover, if the thiols and the strong reducing agent are mixed with the gold-containing compound (HAuCl₄) at the same time, the gold-containing compound will react with the strong reducing agent, but not thiols. Accordingly, the steps (i) and (ii) should be conducted separately. In addition, the step (i) of the procedure has to be conducted under controlled conditions, i.e., 0° C. and very slow stirring rate. Therefore, a simplified and safe procedure for forming the thiol modified gold nanoclusters is still desired.

### SUMMARY OF THE INVENTION

The object of the present invention is to provide a method for making a fluorescent gold nano-material that emits red fluorescence.

According to the present invention, a method for making a fluorescent gold nano-material having a gold nanocluster and thiol ligands on a surface of the gold nanocluster, comprises:

reacting a mixture of a gold-containing compound, an alkyl alcohol, and a thiol compound.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 shows two pictures respectively illustrating a fluorescent gold nano-material of Example 5, before and after centrifugation, according to this invention;

FIG. 2 is a fluorescence spectrum of a fluorescent gold nano-material of Example 1 according to this invention;

FIG. 3 is a fluorescence spectrum of a fluorescent gold nano-material of Example 2 according to this invention;

FIG. 4 is a fluorescence spectrum of a fluorescent gold nano-material of Example 3 according to this invention;

FIG. 5 is a fluorescence spectrum of a fluorescent gold nano-material of Example 4 according to this invention;

FIG. 6 is a fluorescence spectrum of a fluorescent gold nano-material of Example 5 according to this invention;

FIG. 7 is a fluorescence spectrum of a fluorescent gold nano-material of Example 6 according to this invention;

FIG. 8 is a fluorescence spectrum of a fluorescent gold nano-material of Example 7 according to this invention; and

FIG. 9 is a transmission electron microscope image of the fluorescent gold nano-material of Example 3 according to this invention.

### DETAILED DESCRIPTION OF THE PREFERRED EMBODIMENTS

According to the preferred embodiment of the present invention, a method for making a fluorescent gold nano-material having a gold nanocluster and thiol ligands on a surface of the gold nanocluster, comprises: reacting a mixture of a gold-containing compound, an alkyl alcohol, and a thiol compound.

The gold-containing compound may be any salt or chemical compound that contains gold. Preferably, the gold-containing compound is gold(III) chloride (AuCl₃), gold(III) bromide (AuBr₃), or chloroauric acid (HAuCl₄). In examples of this invention, the gold-containing compound is gold(III) chloride.

Preferably, the alkyl alcohol is C₄ to C₆ alkyl alcohol. More preferably, the alkyl alcohol is pentyl alcohol.

Preferably, the thiol compound is selected from alkylthiol, mercaptoalkyl acid, mercaptoalkyl alcohol, mercaptoalkyl amine, and a salt of mercaptoalkyl amine.

The alkylthiol is for example, but not limited to, C₂ to C₁₆ alkylthiol. Preferably, the alkylthiol is selected from 1-dodecanethiol, 1-butanethiol, 1-hexanethiol, 1-octanethiol, 1-undecanethiol, 1-hexadecanethiol, and combinations thereof. In examples of this invention, the alkylthiol is 1-dodecanethiol.

The mercaptoalkyl acid is for example, but not limited to, C₂ to C₁₆ mercaptoalkyl acid. Preferably, the mercaptoalkyl acid is selected from 11-mercaptoundecanoic acid, 3-mercaptopropionic acid, 6-mercaptohexanoic acid, 8-mercaptooctanoic acid, 12-mercaptododecanoic acid, and combinations thereof. In the examples of this invention, the mercaptoalkyl acid is 11-mercaptoundecanoic acid.

The mercaptoalkyl alcohol is for example, but not limited to, C₂ to C₁₆ mercaptoalkyl alcohol. Preferably, the mercaptoalkyl alcohol is selected from 2-mercaptoethanol, 3-mercapto-1-propanol, 4-mercapto-1-butanol, 6-mercapto-1-hexanol, 8-mercapto-1-octanol, and combinations thereof. In examples of this invention, the mercaptoalkyl alcohol is 2-mercaptoethanol.

The mercaptoalkyl amine is for example, but not limited to, C₂ to C₁₆ mercaptoalkyl amine. Preferably, the mercaptoalkyl amine is selected from 2-mercaptoethyl amine, 11-mercaptoundecanyl amine, and the combination thereof. Examples of the salt of the mercaptoalkyl amine include, but are not limited to, a salt of 2-mercaptoethyl amine, a salt of 11-mercaptoundecanyl amine, and the combination thereof. In examples of this invention, the salt of the mercaptoalkyl amine is 2-mercaptoethyl amine hydrochloride.

Preferably, the gold-containing compound in the mixture has a concentration ranging from 0.1 to 50 mM, more preferably, from 0.1 to 10 mM, and most preferably, from 0.1 to 5 mM. When the concentration of the gold-containing compound is too high, the particle size of the gold nano-material made therefrom may be excessively large. On the other hand, when the concentration of the gold-containing compound is too low, the manufacturing efficiency is undesirably low.

Preferably, a mole ratio of the gold-containing compound to the thiol compound ranges from 1:1 to 1:10, and more preferably, from 1:1 to 1:6.

The gold-containing compound, the alkyl alcohol, and the thiol compound may be mixed at room temperature. Alternatively, the alkyl alcohol may be preheated to a reaction temperature, followed by mixing with the gold-containing compound and the thiol compound. Preferably, the reaction temperature ranges from 25° C. to 100° C., and more preferably, from 25° C. to 90° C.

The reaction mechanism among the gold-containing compound, the alkyl alcohol, and the thiol compound is speculated about first reduction of Au(III) of the gold-containing compound to Au(I) by reaction of the gold-containing compound with the thiol compound and then second reduction of the Au(I) using the alkyl alcohol. Since the alkyl alcohol is not a strong reducing agent and will not involve the reduction reaction between the gold-containing compound and the thiol compound, the same can be added with the gold-containing compound and the thiol compound before the first reduction.

Preferably, after the step of reacting the mixture, the method of this invention further comprises a purification step for purifying the fluorescent gold nano-material from the reacted mixture. The purification step can be conducted by, e.g., centrifugation, dialysis, chromatography, extraction, distillation, vacuum concentration, etc.

The fluorescent gold nano-material made from the present invention emits red fluorescence. Preferably, the fluorescent gold nano-material has an emission spectrum that ranges from 550 nm to 700 nm.

Preferably, the particle size of the fluorescent gold nano-material of this invention is lower than 3 nm, and more preferably, lower than 2 nm.

This invention is explained in more detail below by way of the following examples. It should be noted that the examples are only for illustration and not for limiting the scope of this invention.

### EXAMPLES

### Example 1

7 μmol of AuCl₃, 15 ml of pentyl alcohol, and 45 μmol of 11-mercaptoundecanoic acid were mixed at room temperature to obtain a mixture, in which the concentration of AuCl₃ was 0.47 mM, followed by reacting the mixture at room temperature for 24 hours so as to obtain a reacted mixture containing a fluorescent gold nano-material of Example 1 dispersed in pentyl alcohol.

### Example 2

7 μmol of AuCl₃, 15 ml of pentyl alcohol, and 45 μmol of 11-mercaptoundecanoic acid were mixed at room temperature to obtain a mixture, in which the concentration of AuCl₃ was 0.47 mM, followed by reacting the mixture at 90° C. for 24 hours so as to obtain a reacted mixture containing a fluorescent gold nano-material of Example 2 dispersed in pentyl alcohol.

### Example 3

14 μmol of AuCl₃, 30 ml of pentyl alcohol, and 83 μmol of 2-mercaptoethyl amine hydrochloride were mixed at room temperature to obtain a mixture, in which the concentration of AuCl₃ was 0.47 mM, followed by reacting the mixture at room temperature for 24 hours so as to obtain a reacted mixture containing a fluorescent gold nano-material of Example 3 dispersed in pentyl alcohol.

### Example 4

48 μmol of AuCl₃, 15 ml of pentyl alcohol, and 208 μmol of 11-mercaptoundecanoic acid were mixed at room temperature to obtain a mixture, in which the concentration of AuCl₃ was 3.2 mM, followed by reacting the mixture at 60° C. for 24 hours. The reacted mixture was subsequently subjected to centrifugation at 5000 rpm for 10 minutes, and supernatant was removed to obtain a crude product. The crude product was washed with pentyl alcohol and subjected to centrifugation to remove supernatant thereof. After repeating the above washing and centrifugation steps twice, the crude product was further washed with ethyl acetate twice and was heated for removing ethyl acetate. Accordingly, a fluorescent gold nano-material of Example 4 was obtained.

### Example 5

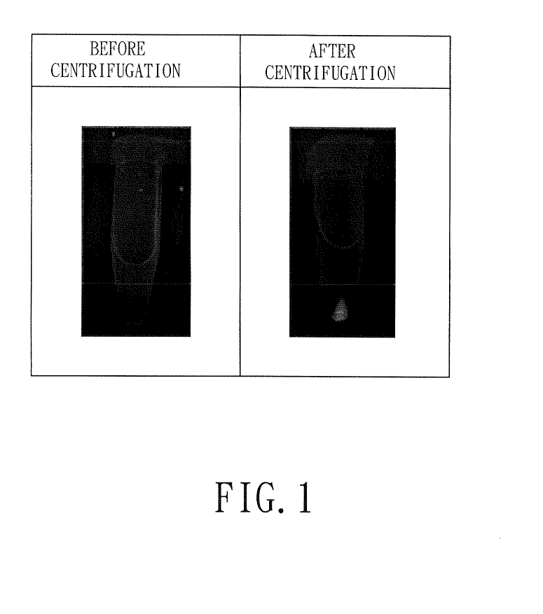

15 ml of pentyl alcohol was preheated to 60° C., followed by sequentially adding with 45 μmol of 11-mercaptoundecanoic acid and 7 μmol of AuCl₃ so as to obtain a mixture, in which the concentration of AuCl₃ was 0.47 mM. The mixture was reacted at 60° C. for 24 hours and then placed in a darkroom, followed by irradiating the mixture using an ultraviolet light with a wavelength of 365 nm and photographing the same. The photograph for the mixture before centrifugation is shown in FIG. 1.

The mixture was subsequently subjected to centrifugation at 5000 rpm for 10 minutes, and the supernatant was removed to obtain a crude product. The crude product was washed with pentyl alcohol and subjected to centrifugation. After repeating the above washing and centrifugation steps twice, the crude product was further washed with ethyl acetate twice, followed by placing the crude product in the darkroom, irradiating the same using an ultraviolet light with a wavelength of 365 nm, and photographing. The photograph for the crude product is shown in FIG. 1.

The crude product was heated so as to remove ethyl acetate and to obtain a fluorescent gold nano-material of Example 5.

Referring to FIG. 1, the crude product after centrifugation emits red fluorescence, which verifies the fluorescent gold nano-material can be produced by the method of this invention.

### Example 6

30 ml of pentyl alcohol was preheated to 60° C., followed by sequentially adding with 83 μmol of 1-dodecanethiol and 14 μmol of AuCl₃ so as to obtain a mixture, in which the concentration of AuCl₃ was 0.47 mM. The mixture was reacted at 60° C. for 24 hours, followed by centrifugation at 5000 rpm for 10 minutes, and removal of supernatant to obtain a crude product. The crude product was washed with pentyl alcohol and subjected to centrifugation to remove supernatant. After repeating the above washing and centrifugation steps twice, the crude product was further washed with ethyl acetate twice and was heated for removing ethyl acetate so as to obtain a fluorescent gold nano-material of Example 6.

### Example 7

30 ml of pentyl alcohol was preheated to 60° C., followed sequentially adding with 86 μmol of 2-mercaptoethanol and 14 μmol of AuCl₃ so as to obtain a mixture, in which the concentration of AuCl₃ was 0.47 mM. The mixture was reacted at 60° C. for 24 hours, followed by centrifugation at 5000 rpm for 10 minutes, and removal supernatant to obtain a crude product. The crude product was washed with pentyl alcohol and subjected to centrifugation to remove supernatant. After repeating the above washing and centrifugation steps twice, the crude product was further washed with ethyl acetate twice and heated for removing ethyl acetate so as to obtain a fluorescent gold nano-material of Example 7.

### Fluorescence Analysis

The fluorescent gold nano-materials of Examples 4 to 7 were dispersed in alcohol. The excitation spectrum and emission spectrum for the fluorescent gold nano-material of each of Examples 1 to 3 (dispersed in pentylalcohol)and Examples 4 to 7 (dispsersed in alcohol) were analyzed using a fluorescence spectrophotometer (F-4500, HITACHI). According to the different compositions of the gold nano-materials, different wavelengths for the excitation light and the emitting light were selected.

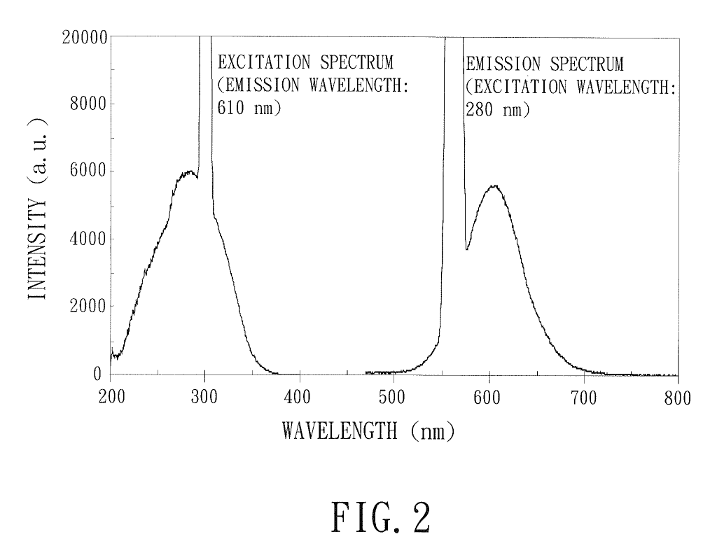

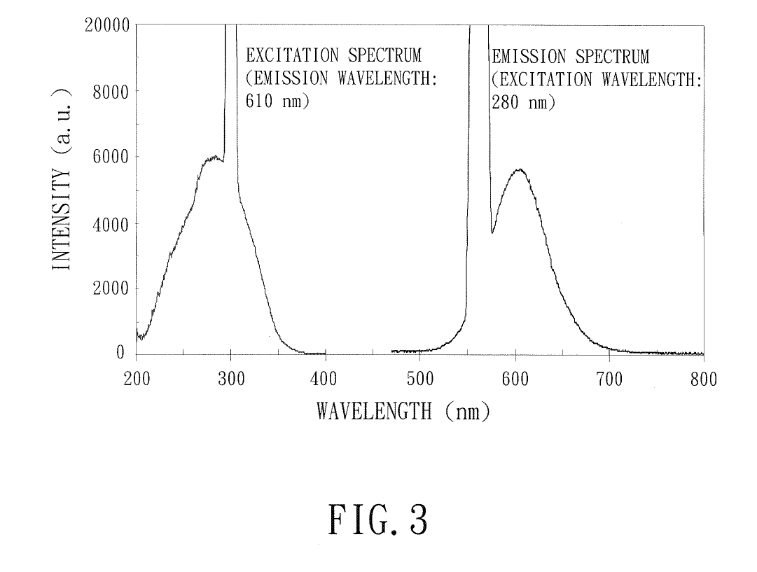

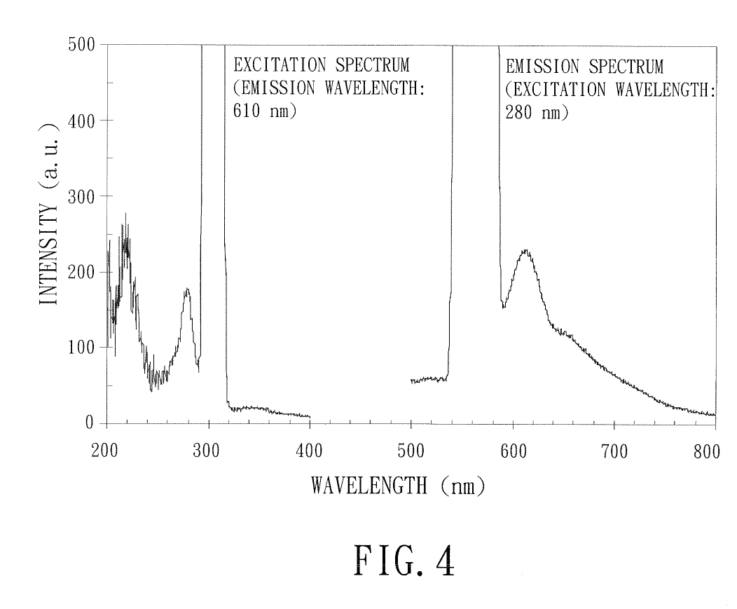

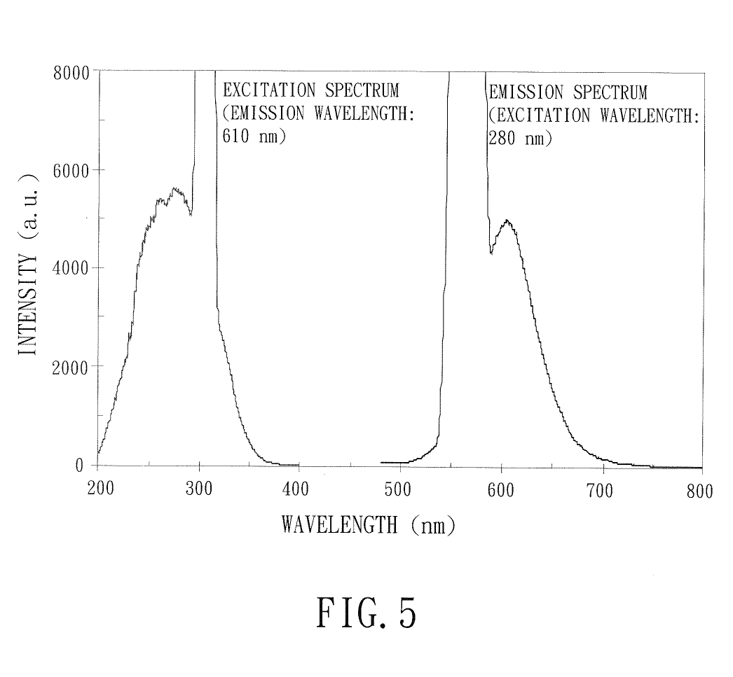

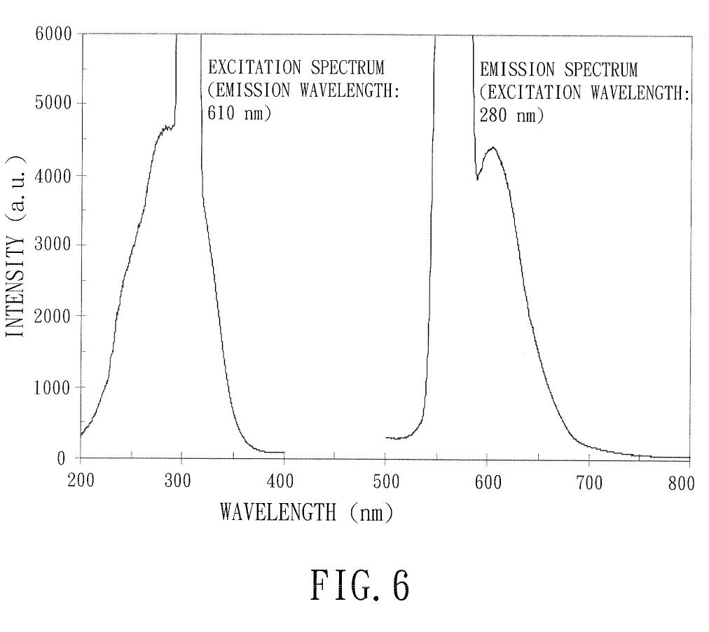

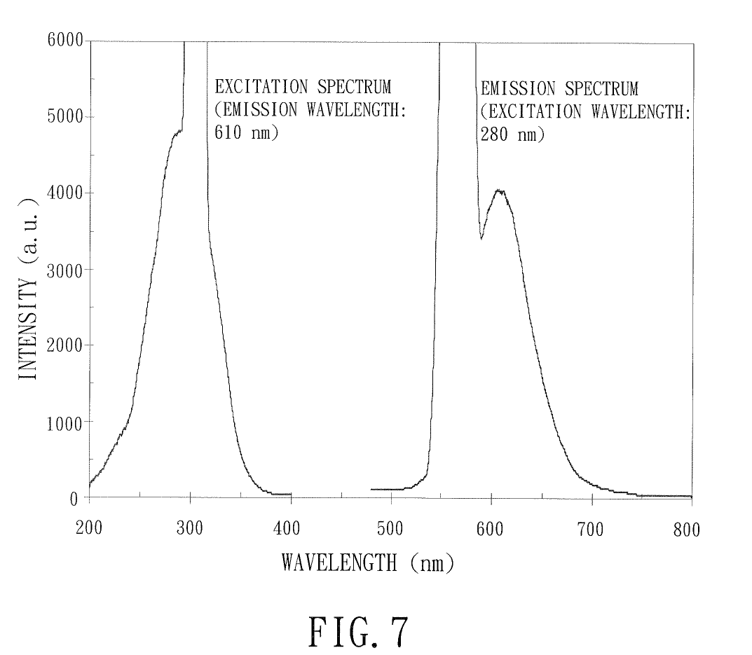

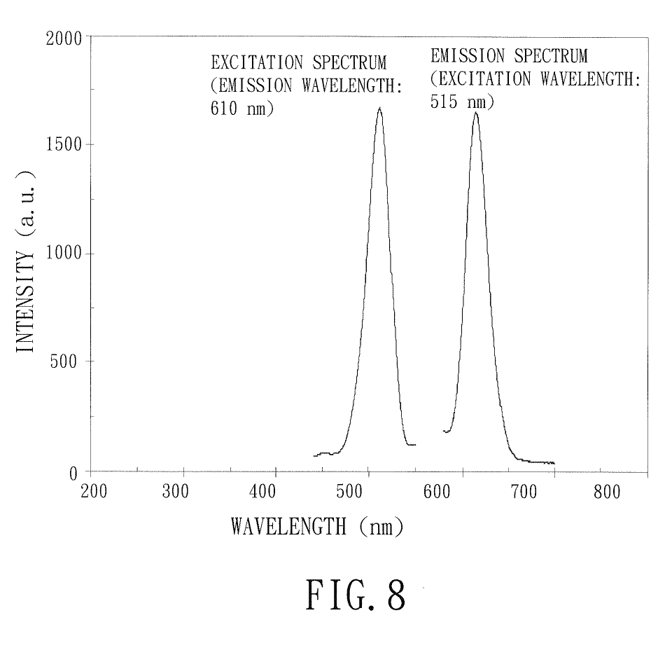

The measurement results of Examples 1 to 7 are shown in FIGS. 2 to 8. It is shown that all of the gold nano-materials prepared from this invention have high fluorescence intensity.

### Appearance Analysis

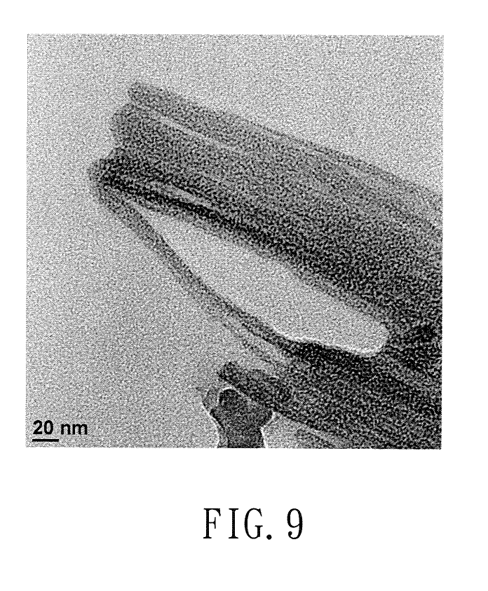

The gold nano-material of Example 3 was dried and observed using a transmission electron microscopy (TEM). The observation result is shown in FIG. 9.

Because the gold nanoclusters have low crystallizations, and are likely to melt under high energy irradiation, determination of particle size thereof is relatively difficult. The same difficulty is also occurred in TEM observation. Although the gold nano-material of Example 3 is somewhat melted, from the photograph in FIG. 9, the particle size thereof can be still determined and is smaller than 2 nm. In summary, by using the alkyl alcohol as a reducing agent and a solvent, the fluorescent gold nano-material of this invention can be formed in a single step without using a strong reducing agent. In addition, the conditions for performing the method of the present invention are relatively easy to be controlled, e.g., at room temperature and stirring without a specifically limited speed.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A method for making a fluorescent gold nano-material having a gold nanocluster and thiol ligands on a surface of the gold nanocluster, comprising:
reacting a mixture of a gold-containing compound, an alkyl alcohol, and a thiol compound.

2. The method of claim 1, wherein the alkyl alcohol is C₄ to C₆ alkyl alcohol.

3. The method of claim 1, wherein the thiol compound is selected from the group consisting of alkylthiol, mercaptoalkyl acid, mercaptoalkyl alcohol, mercaptoalkyl amine, and a salt of mercaptoalkyl amine.

4. The method of claim 1, wherein the gold-containing compound is selected from the group consisting of gold(III) chloride, gold(III) bromide, and chloroauric acid.

5. The method of claim 1, wherein the gold-containing compound in the mixture has a concentration ranging from 0.1 to 50 mM.

6. The method of claim 1, wherein a mole ratio of the gold-containing compound to the thiol compound ranges from 1:1 to 1:10.

7. The method of claim 1, wherein the reaction of the mixture is conducted at a temperature ranging from 25° C. to 100° C.

8. The method of claim 1, further comprising, after the step of reacting the mixture, purifying the fluorescent gold nano-material.

9. The method of claim 1, wherein the fluorescent gold nano-material has an emission spectrum ranging from 550 nm to 700 nm.
